(19) United States
(12) Patent Application Publication
(10) Pub. No.: US 2017/0109665 A1
(43) Pub. Date: Apr. 20, 2017

(54) RESOURCE CREW MANAGEMENT

(71) Applicant: SERKO LIMITED, Auckland (NZ)

(72) Inventors: Robert James SHAW, Auckland (NZ); Darrin John GRAFTON, Auckland (NZ)

(21) Appl. No.: 15/392,378

(22) Filed: Dec. 28, 2016

Related U.S. Application Data
(62) Division of application No. 14/570,614, filed on Dec. 15, 2014.
Application No. 14/570,614 is a continuation of application No. PCT/NZ2013/000100, filed on Jun. 12, 2013.

(30) Foreign Application Priority Data
Jun. 14, 2012 (NZ) 600619

(51) Int. Cl. G06Q 10/02; G06Q 10/10

(52) U.S. Cl. CPC G06Q 10/02; G06Q 10/10; G06Q 50/14

(57) ABSTRACT

An online booking system caters for the corporate booking of the travel of a number of people to a single destination or multiple destinations by providing a file with details of the trip destination, the people involved and the criteria which override the normal corporate travel criteria. The booking system then merges this with the normal corporate travel criteria and any external profile criteria of the individuals and books individuals to the destination before issuing the bookings.

### GLOSSARY

“Profile”1

Refers to the information stored by a travel provider in relation to an individual. Typically this is name, address, preferences for seating and class, etc.

“Policy”

Means the rules which an individual travelling for a must abide by if possible. Typically these relate to expense levels or timeliness.

### FIELD OF THE INVENTION

The invention relates to the semi-automatic booking of travel and accommodation for an organisation following the rules established by the organisation. The travel bookings concerned are for an unlimited number of travellers, can be from any origin, travelling to any destination with any number of flights and varying itineraries.

### BACKGROUND OF THE INVENTION

Booking systems exist which interface with either various travel or accommodation organisations or with the native booking systems of such groups as airlines, vehicle rental companies or hotel chains.

Most of these booking systems are adequate for booking individuals, families or groups such as teams, however they typically do not allow for corporate travel bookings where individuals have specific travel or accommodation preferences or rights, such as first class travel and accommodation or restricted accommodation costs and the cheapest travel available.

In particular they do not allow for what might be called a crew movement, crew rotation, swing or shift plot where a block of persons, such as a mining shift, are scheduled to be at a certain destination at a specified time.

Typically travel will be booked through a standard web based travel booking system run by a Travel Management Company (TMC) into which may carry the profiles of the persons to travel (name, gender, contact, travel preferences, etc.). This system may interface with the actual travel providers (the airline, the hotel) software to book the required travel seats or accommodation or it may book with a Global Distribution Systems (GDS) booking system.

The organisation may have preferences which may specify for a particular standard operation the required destination, the time frame for arriving at the destination, the level of travel (first class, business, economy, etc.), the level of accommodation at destination or transfer location. To this may be supplied the identifiers for the passenger records in the booking system.

Booking on an individual basis for a mining shift of perhaps a hundred persons is a long and involved operation in normal circumstances. A bulk booking in the names of the same persons is normally not possible because of differing travel and accommodation criteria, for instance for a shift manager versus a mining face operator.

In addition individuals may have profiles within the booking system, for instance for vegetarian meals or first class accommodation which may override or be overridden by certain organisational preferences.

The present invention provides a system which takes account of such preferences and profiles to provide a form of bulk booking which resolves all conflicts.

### SUMMARY OF THE INVENTION

A method of booking travel for a number of individuals for a corporate body by:
providing a booking system,
storing in the booking system information relating to travel policies of the corporate body,
storing in the booking system information relating to the details and travel policies of individuals,
creating a bulk file relating to the travel for a corporate body of a number of individuals to a destination
the bulk file including details of individual traveller and additional travel policy properties of the corporate body,
creating within the booking system a crew movement action relating to the travel of a number of individuals to a single destination or a variety of destinations,
retrieving from the stored information the corporate body travel policies for that action,
retrieving the details of the individual travellers from the bulk file,
retrieving any further details and travel policies of the individual travellers from the stored information,
merging the corporate body, individual traveller and bulk file policies,
individually booking each individual traveller to the destination,
issuing the bookings.

Preferably the bulk file includes at least some travel policy properties of at least some individuals.

Preferably the travel costs are paid at the same time as booking.

A travel booking system for booking the travel of a number of individuals by a corporate body and having:
an information storage system storing details of the corporate body travel rules,
access to a travel booking provider,
a bulk file parser reading a bulk file provided by the corporate body,
the bulk file including details of the required destination of the number of individuals, details of the individuals sufficient to create a booking,
a travel booker booking individually the travel of each of the number of individuals to the destination in compliance with the corporate body travel rules,
an email issuer issuing emails to individuals successfully booked.

Preferably the bulk file includes additional travel rules and the booking process provides a rule merger merging rules in a specified manner to provide a booking in accord with the merged rules.

### BRIEF DESCRIPTION OF THE DRAWINGS

FIG. 1 shows a diagram of the process equipment.

FIG. 2 shows a flow diagram of the basic process of booking travel.

FIGS. 3A and 3B show details of a bulk file shown as a spread sheet.

FIG. 4 shows an entry screen to the Group booking system.

FIG. 5 shows the initial setup screen for a bulk booking session

FIG. 6 shows a display and edit screen for individuals of a bulk load

FIG. 7 shows the entry screen for the flight membership entry of an individual

FIG. 8 shows the entry screen for most details of an individual

FIG. 9 shows the assembled data from a bulk file before booking commences

FIG. 10 shows a flight lookup facility

FIG. 11 shows a cost centre lookup facility

FIG. 12 shows a later view of FIG. 9 after some amendment

FIG. 13 shows the on screen display as the bookings are made

FIG. 14 shows the bookings which have been made

FIG. 15 shows an email with a spreadsheet attachment of the bookings

FIG. 16 shows the spreadsheet with booking details

FIG. 17 shows a search facility for the bookings

FIG. 18 shows a filtered selection of bookings

### DESCRIPTION OF THE INVENTION

### Example 1 with Reference to the Drawings

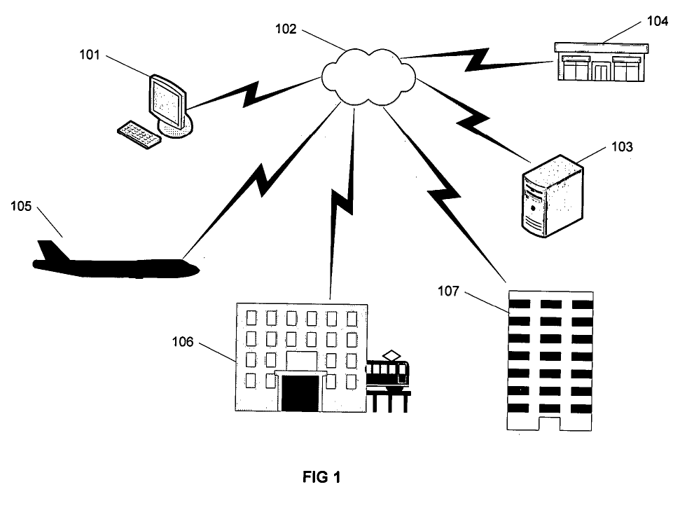

The invention involves the process equipment of FIG. 1 where an operator at a computer screen 101 provides to an online booking tool at server 103 a file containing the relevant details for a bulk booking. This will include the corporate body booking the travel, the destination for the individuals, at least one of the following: the time at which they are to depart; the time at which they are to be at the destination; the required flight number, the location they will be travelling from, each individual's booking details (name, address, contact) and optionally an individual's profile of any special requirements for this particular travel. Also stored at server 103 are corporate details of the corporate travel rules, for instance the allowed fare levels for various individuals based on their corporate position, the type of accommodation at any transfer points, the amount of checked in baggage, the allowable expenses en route. Also included may be details of any travel or accommodation providers who have agreed to special rates, and details of how to get the rates when booking.

Additionally available to the server or stored at the server are the individuals profile details, which may include such things as the individual's airline meal preference and preferred seating position on an aircraft.

The booking tool in server 103 may be in contact with a Travel Management Company (TMC) 104 which can carry out the actual booking with an airline 105, a rail service 106 or a hotel chain 109 in accord with the rules and preferences, or the booking tool itself may carry out these tasks.

To start the process a bulk file is required for every crew movement. This file, which is preferably an XML document but which may be a spreadsheet or other document, includes the corporate body to which it applies, destination and time details (and may include the actual flight details), the details of which individuals are to be scheduled to travel and where they are travelling from, at least their minimal travel details (e.g. name, address, contact number, email, passport number if relevant), details of specifics for this travel (e.g. wheelchair required), corporate travel rules which apply only to this trip (e.g. transfer accommodation must be at a particular hotel, air fares cannot exceed a certain figure, the cost centre is “Shift 20121120”). The file is uploaded to the server before the booking process starts.

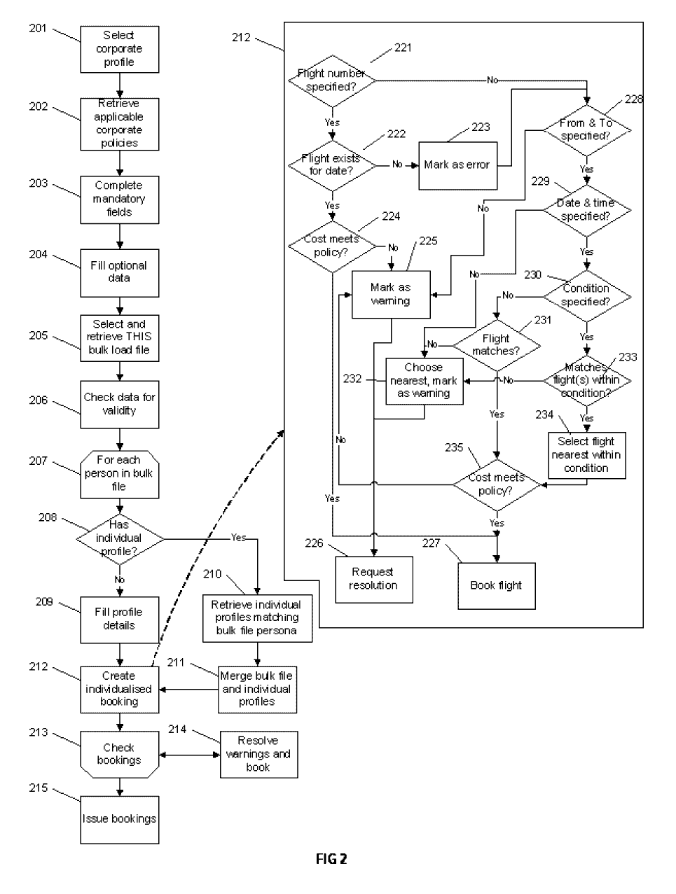

FIG. 2 shows the process of carrying out the booking in which the operator at computer 103 first selects the correct corporate profile at 201 (although this may be part of the logging in process required by the booking tool). The system retrieves the applicable corporate policies at 202 and allows the user to fill any mandatory fields such as selecting one policy from the retrieved corporate policies, and a bulk file to load at 203 before entering any optional fields at 204. The optional fields may include an email or text message facility to advise the user when the lengthy bulk load booking process is completed.

The nominated bulk load file is then retrieved at 205 and parsed in a validity check at 2065 so that any missing mandatory information can be entered. The parsing may include retrieving details of an individual from the corporate information if an employee ID is present. Missing information might, for instance, be the details of an individual which were not available when the bulk file was created or the employee ID if this individual is not entered as a contractor. The bulk file may also include an individual traveller's profile ID (Passenger Name Record—PNR) in some TMC system, and these details also may be retrieved.

Once the mandatory fields have been entered any optional fields may be entered and the system then moves on to loop 207 to book each individual trip. At 208 the individual entry in the bulk file is checked for a profile or a link to a profile and if one is found it is retrieved at 209. In this case the retrieved profile preferences are merged with the corporate rules in the bulk file and the corporate rules in the corporate file to provide a prioritised set of rules as to what flight should be taken, what fare levels are allowable, what should be booked or marked as waitlisted, whether interconnecting flights using an overnight stop are allowable, what level of accommodation is allowed at an overnight stop, what expenditure allowance is set, whether minimum fare levels can be overridden and to what extent, what arranged fares are available, what charter helicopter flights may be available from an airport destination and so on.

When these factors are all taken into account and any manual input received the individual booking will be made at 212 and the next individual booked.

Each individual booking is processed as at expanded box 212 in which the passenger and flight details received are resolved into a booking if possible. If a flight number is specified at step 221 this is checked at 222 to ensure the flight exists on that date, then at 224 to ensure that the seat cost will meet the group and individual policies of the cost centre. If it does then the flight can be booked at 227 and the system moves on to the next flight of that passenger or the next passenger.

Where a flight does not exist at the specified date the entry may be marked as in error and may proceed to attempt to book any flight at the specified date and time via 228. Where the flight cost is outside policy at 224 then a warning is raised and the processed data will not be booked but instead marked at 226 for correction and booking after the bulk file is processed.

Where no flight number is specified the departure and arrival locations are checked at 228, with a warning being generated if these are invalid, and the date and time of departure and arrival checked at 229. Again a warning is generated at 225 if these are absent or in obvious error but optionally processing can continue with the first available flight being checked for space, and compliance with policy costs at 230.

A further check at 233 resolves the question of how close to a preferred time a flight must be to allow its selection. The bulk file has a column relating to “Condition” which may have several different values. Nominally these are blank, ‘at’, ‘before’, ‘after’ or ‘near’. The policy file may set time values relating to these. For instance a particular policy file may specify that a blank may mean that a flight should be within 1 hour of the specified time, an ‘at’ that the flight is within 10 minutes of the time, a ‘near’ within two hours, a ‘before’ within two hours before the specified time and an ‘after’ within two hours after the specified time. These times may vary for individual policies, for group policies, or for enterprise policies, with the most relevant applying. Equally the weighting given to a departure time versus an arrival time may be weighted differently by different policies.

Given all these criteria the available flights are considered at 234 and the flight most nearly meeting the criteria and closest to any specified time is chosen. A final check that the cost meets the policy requirements is made at 235 allowing a different flight to be tried if too costly, and the flight booked at 227.

Where any warnings were generated the flight is not booked, but rather flagged with a warning and marked up with the flight times that most nearly met the available criteria.

Once all bookings are completed the loop ends at 213, any warnings or errors from the booking process resolved at 214, with individual user completion of these and the bookings are issued at 215. All bookings are made against a particular corporate cost centre, but the particular centre may vary with the individual concerned even though normally the cost centre specified in the bulk file will prevail.

Individuals will be supplied with the booking details, normally by system email, so that these can be modified directly with the provider if necessary, however it is expected that the individuals will comply with corporate rules.

Where errors or failures occur with the bookings a system report is provided so that these can be corrected and additionally a confirmation report of each successful booking is provided.

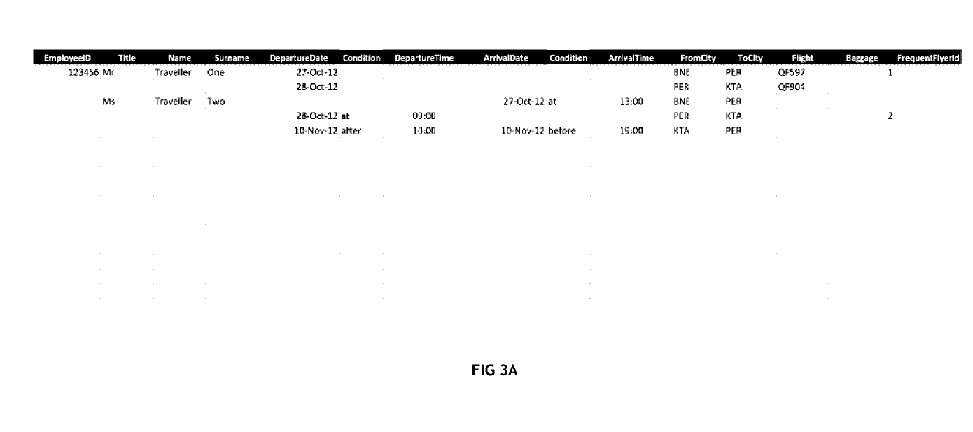

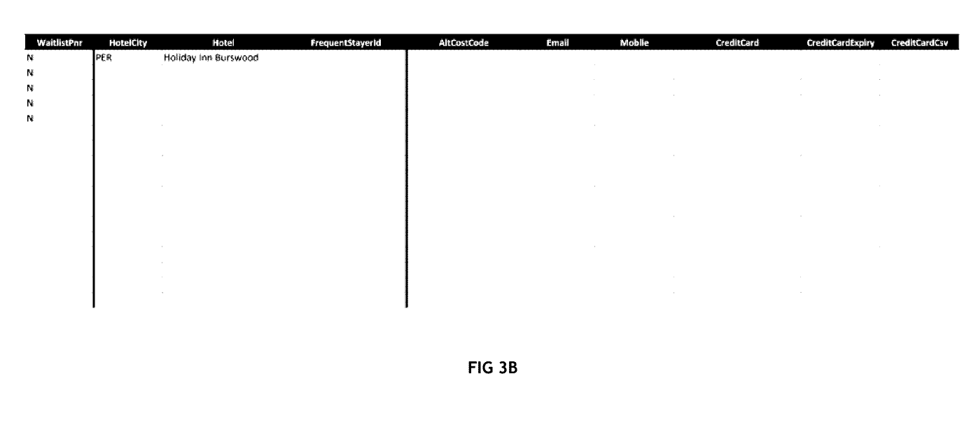

FIG. 3 shows a sample bulk file as two individuals in a spreadsheet (broken into two parts) and showing the employee ID, the surname, first name, title, the departure date and perhaps time of travel, the arrival time date and time, the origin and destination—the preferred flight number, the number of bags, any frequent flyer ID, any preferred hotel for a transfer destination the individuals email and mobile number, credit card number, expiry date and CSV

Other data may be included, for instance to cover an international flight.

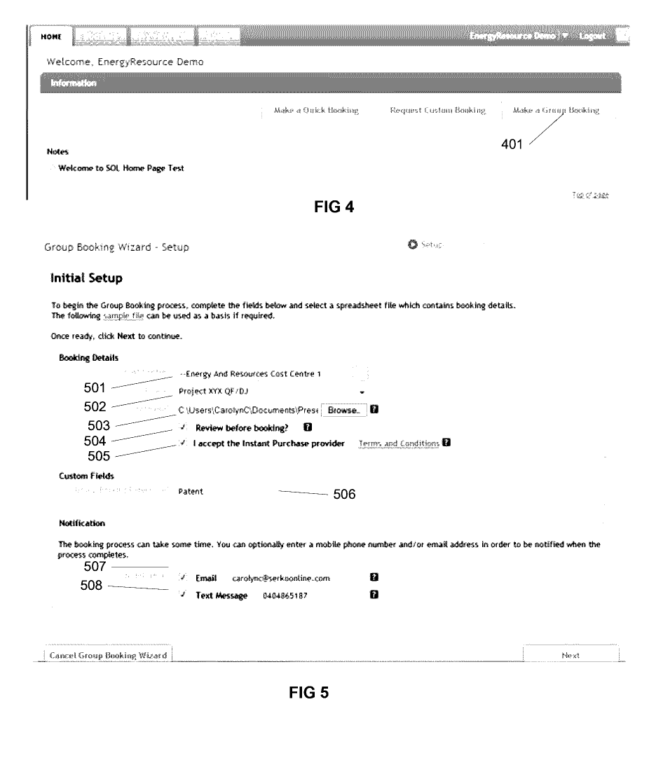

FIGS. 4 through 15 show the process of booking a number of passengers using a bulk file such as that of FIG. 3. FIG. 4 shows the initial screen of a booking system with an option 401 which allows the creation of a group booking.

On selection of this option the screen of FIG. 5 is shown which allows the entry of the accounting cost centre for the group booking at 501, the group policy for the bookings at 502 and the filename of the spreadsheet or other processable document at 503. Other entry fields include options to review the entries before booking at 504, and an acceptance of the Providers terms at 505. Custom fields may be entered at 506 and a call-back option (email and/or mobile) at 507, 508 for the completion of booking may be offered.

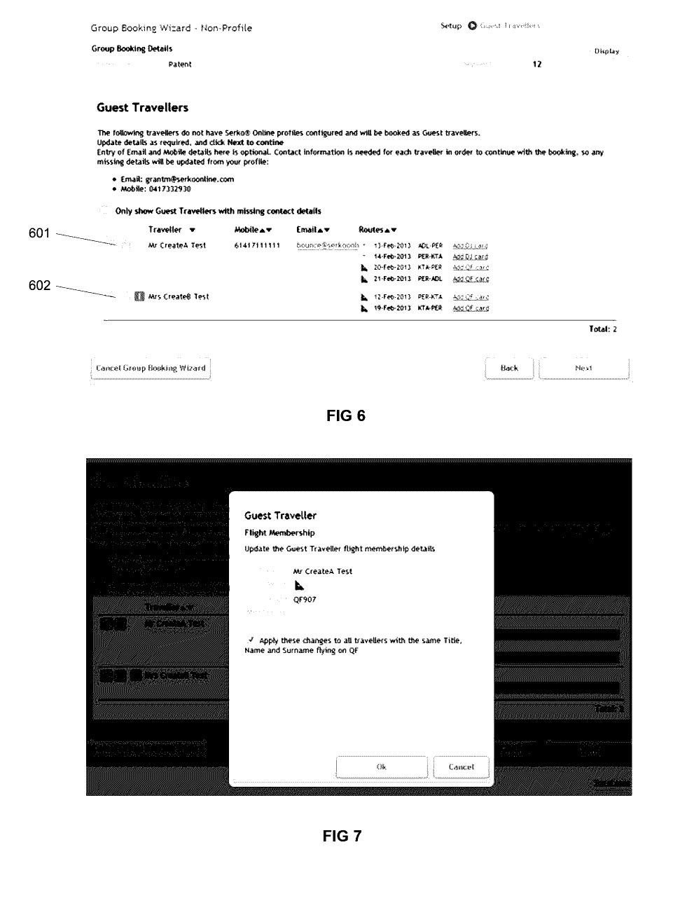

FIG. 6 shows the results of a validation after the bulk file is loaded and the passenger group details are retrieved from it. It differentiates the travellers who are NOT in the profile database, shows what information is present and allows entry of missing detail.

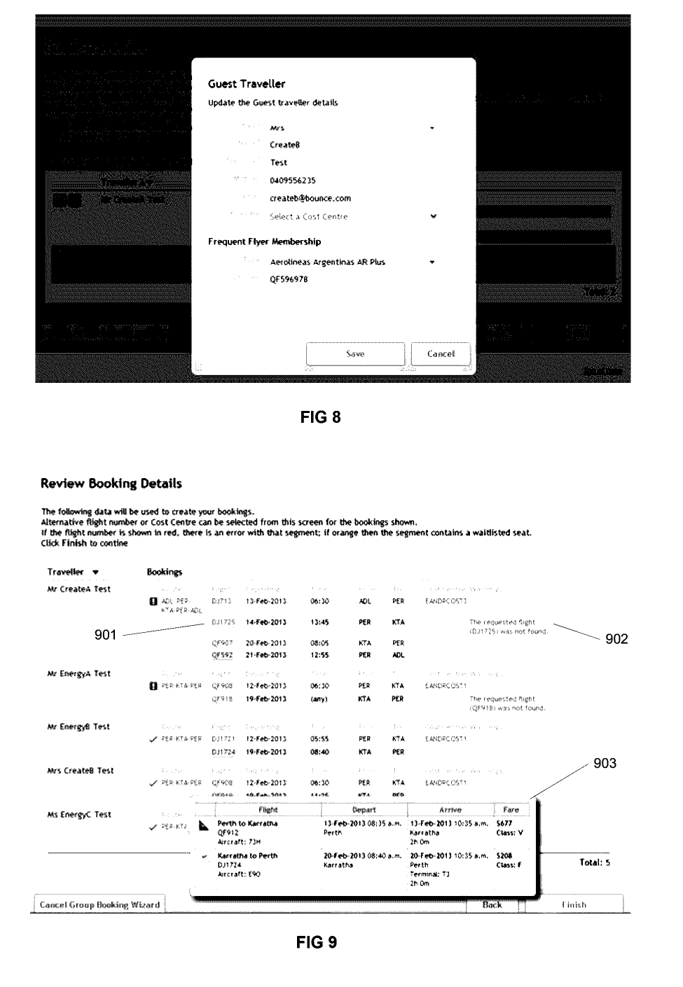

Thus traveller Mr CreateA Test had mobile number and email details in the bulk file and does not show the warning icon of Mrs CreateA Test, while Mr CreateA Test has no frequent flyer details for two of four flights. The missing details from the profile may be added via the Flight Membership entry screen of FIG. 7 or the Guest Traveller details entry screen of FIG. 8.

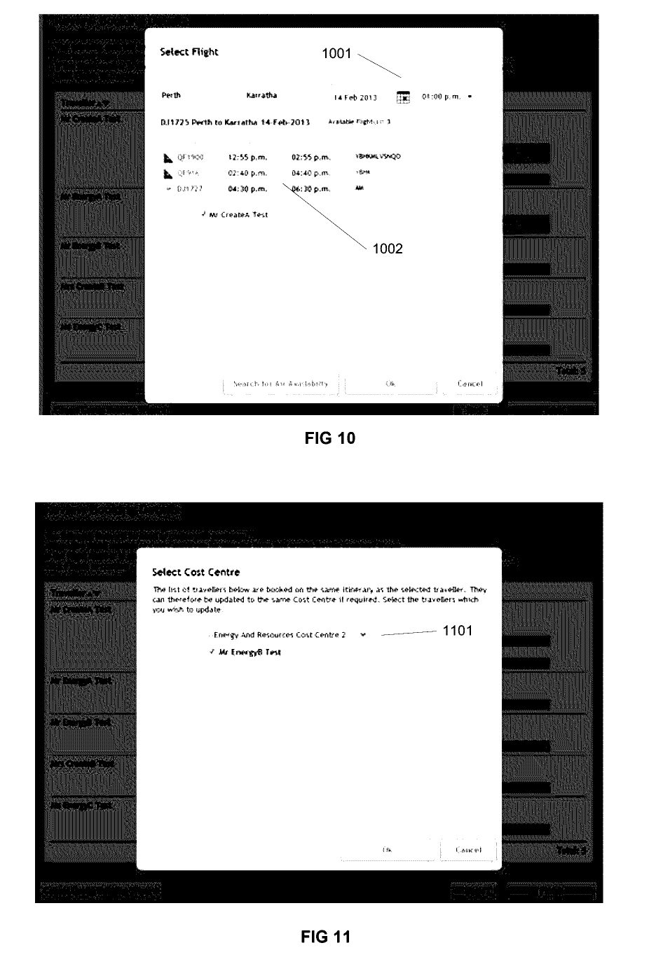

Once all detail is entered the full list from a bulk file as shown at FIG. 9 may be reviewed. As part of the bulk file validation all of the detail will have been checked as far as possible, for instance flight numbers will have been verified as to whether the flight exists for the specified date and time, or if no flight number was specified a tentative flight will have been entered from a review of the required date, time and cost centre fare policy applying to the passengers profile. Where a specified flight cannot be found, as at errors 901, 902, a selection option 903 available for instance through a mouse hover, may allow choice of an available flight at an equivalent time. Alternatively the passengers date and time may be altered and an alternative flight located which will also meet the fare policy of the passenger. FIG. 10 shows the flight selection screen with over-rideable date and time options 1001 and a selection for the flights found at 1002. FIG. 11 shows the selectable cost centre at 1101 allowing this to be changed if required.

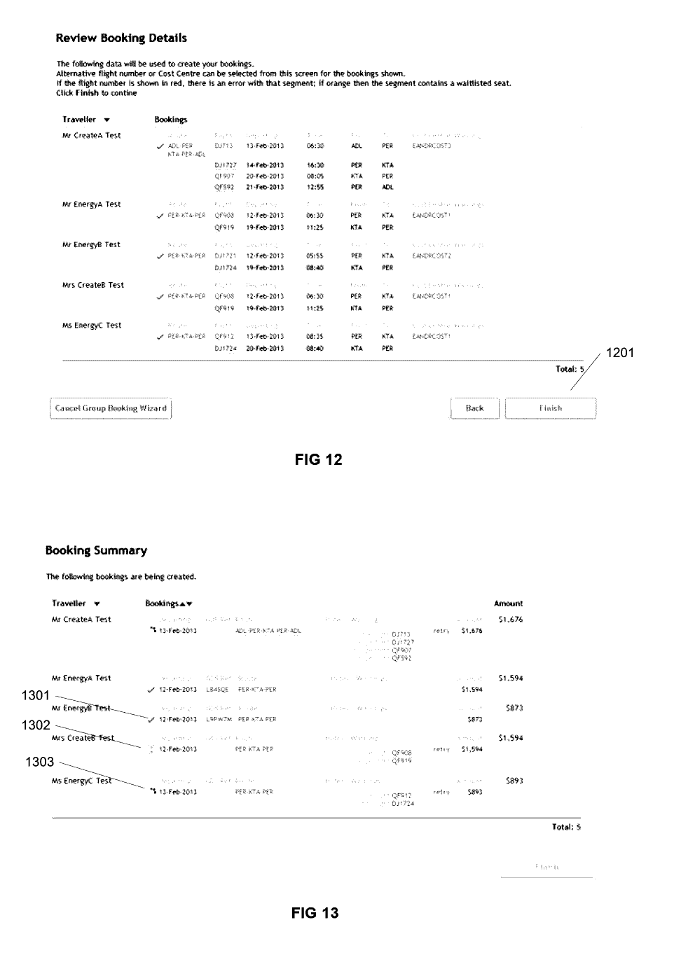

Once all the errors have been corrected a list clear of errors is displayed as at FIG. 12. Clicking the “Finish” button 1201 initiates the booking process, showing the summary at FIG. 13 while this is occurring. Each passenger and flight will be update to show the current status of the booking as at 1301, 1302, 1303. Since a bulk booking can take considerable time the process will be only one window of the multi-window booking processing system.

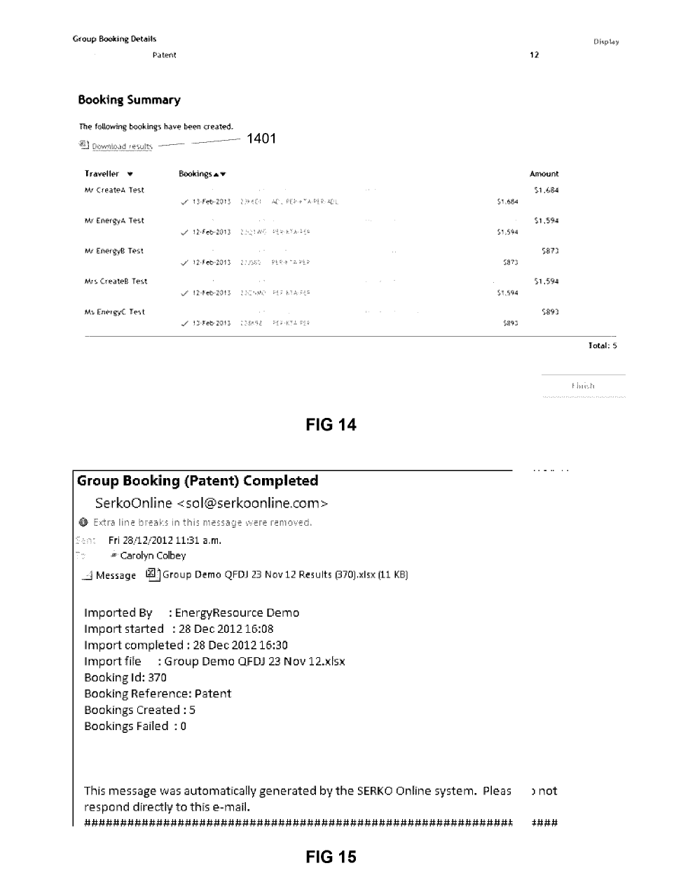

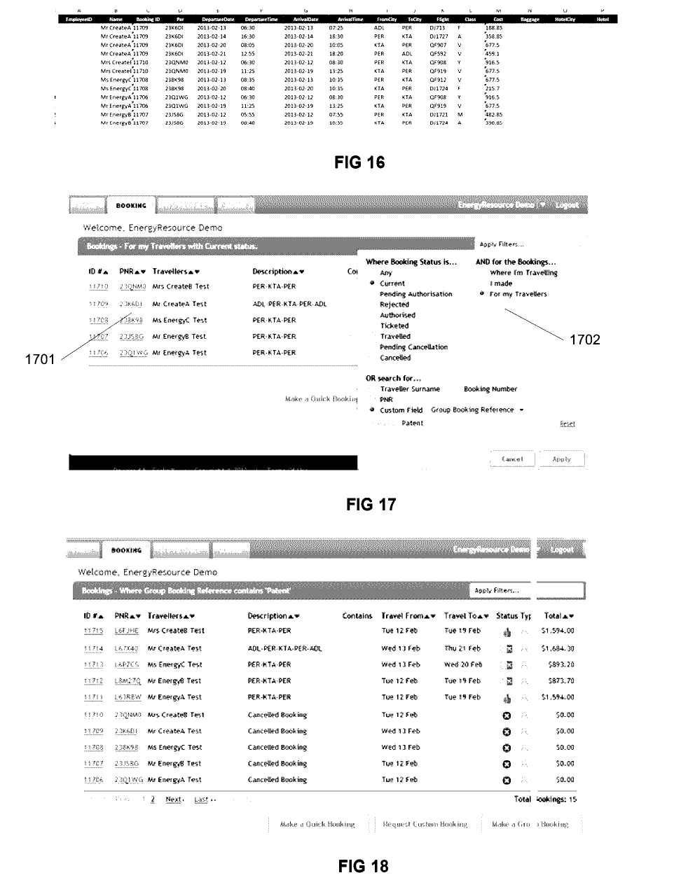

Once the booking process is completed the completed summary as at FIG. 14 is displayed. An option to download the results at 1401 may result in an email as at FIG. 15 with an attached spreadsheet or similar as shown in FIG. 16 giving details of the passenger, flights, dates, times etc.

The bookings can now be individually queried or searched, and FIG. 17 shows the results at 1701 of the use of a filter query screen as shown at 1702 while FIG. 18 shows the result of search for the original group booking.

### Example 2

This example is a high level description to explain the Crew Movement functionality.

Core Crew Movements

(Also known as Shift Plots, Crew Rotations, Swing, FIFO)

Considerations and Information

The key development objective is to provide the ability for data to be pulled from a source such as spread sheet of crew details and for this data to be used in an automated booking process via Serko Online.
The drawings are for illustrative purposes only at this time. The majority of clients will be willing to work with Serko to provide the data in the format we determine most beneficial but the amount of variation that can be achieved may be determined by the client data source producing the employee detail for the Crew Movement requirements.
The number of days for rotations will vary by company and by type of employee. The rotations could be two weeks on, then one week off or eight days on and six days off or any other variation according to individual company requirements. Clients will want to book three to four sequences of rotations in a single bulk load. Booking numbers could vary anywhere from fifty to three hundred or more depending on requirements.
At present, there are one or two very basic automated tools in place for these Crew Movement requirements. An existing travel booking system uses a spread sheet which was run through a script interfacing with the GDS, automating the booking process directly via the GDS. Clients now want to manage the process themselves rather than relying on the TMC, therefore requiring the automated booking process to be enabled via Serko Online.
Additionally, in order to manage the entire process internally, clients want the ability to make and manage changes to all bookings. Particularly important is the ability to make changes post ticketing so these requests do not have to be sent back to the TMC.
Bookings need to be individual passengers.

Fare Types
In general, clients will have negotiated agreements with one or more nominated airlines, for example in Australia they may have an agreement with any of the major carriers
Any potential client with a travel expenditure exceeding 1.5M-2M dollars is eligible for an agreement.
Due to the enormous demand for seats on the common routes (Karratha, Port Hedland, Broome, Exmouth, Newman & Kalgoorlie), neither of the major carriers load inventory at the lower cost end of the fares grid. As such, Best Fare of the Day (BFOD) policies are not a feasible cost option and the best private fare that can be negotiated by the client becomes the BFOD for the client.
For Western Australia, one of the major airlines holds the main market share of negotiated agreements with the target client base. Most agreements will have ‘B’ class and a ‘Y’ class option, with B class at a slightly lower cost. When booking, the first option will be to secure B class and then Y class if the B class inventory has been sold. Y class will be the only last seat availability class.

Form of Payment

In general, there will be a single credit card form of payment for the majority of travellers on a spreadsheet roster, however ‘Contractors’ (guest travellers) may need a to be charged to a different cost centre and/or a different credit card.

Shutdown Movements

Considerations and Information

Shutdowns are scheduled regularly for major maintenance work to take place on some part, or all of, the mine site or offshore facility (e.g. rig or vessel). These can occur once or twice a year with a significant notice period or could be scheduled urgently in the case of emergency maintenance being required.
Shutdowns can require the movement of up to or sometimes exceeding 1,000 travellers within a 2-7 day period to a single destination.
Contractors feature significantly in shutdown travel requirements as all type of maintenance work (e.g. electrical, mechanical, and geological) is required to be done at the same time to minimise the down time of the mine site or facility.
When booking shutdown travel, there will need to be an identifying field in order to identify which Contractor company each traveller is working with.

Fare Types

Refer to ‘Fare Types’ for Crew Movements.

Form of Payment

In general, there will be a single credit card form of payment for the majority of travellers on a spreadsheet roster, however ‘Contractors’ (guest travellers) may need a to be charged to a different cost centre and/or a different credit card.

Charter Flights

Many companies contract charter flights (either wholly or partially) to move employees to and from site. If charter flights are used, the travel policy logic will generally be—fully utilise the charter flight seat allocation before booking any scheduled services.

Our objective is to allow the loading of the charter flight inventory into Serko Online to allow the seats to be booked in conjunction with accommodation and transfers (see below) so that the inventory is being managed ‘live’ and all employee end to end travel bookings are consolidated in a single system.

Camp (Onsite) Accommodation Management

Due to the remote locations of the sites, potential clients will most likely have built their own accommodation camps. At present many clients are managing the camp accommodation inventory separate to the flight booking process, resulting in an inefficient manual process to ensure travellers have accommodation confirmed and the inefficient use (or non-use) of camp rooms in many circumstances.

Our objective is to allow the loading of the camp accommodation inventory into Serko Online to allow the rooms to be booked in conjunction with flights and transfers (see below) so that the inventory is being managed ‘live’ and all employee end to end travel bookings are consolidated in a single system.

Transfer Management

‘Transfers’ refers to the bus/alternative vehicle transfer that will take the employees from the airport on arrival to the mine site/facility.

The objective is to manage the transfers' inventory in the same way as charter flights and camp accommodation.

Helicopter or Alternative Connecting Services

*Note that this requirement information is for information purposes only and may not form any long term development plans dependent on individual client requirement.

There is regularly a requirement for travellers to connect from a fixed wing flight to an alternative service in order to arrive onsite. This is particularly relevant to the Oil & Gas industry where travellers are booked on offshore helicopter services to take them to the rig or vessel.
At present, the TMC booking process* for a traveller is:
Make the fixed wing booking via the GDS
Make the helicopter service booking in the client's software system for the helicopter inventory
Manually load the helicopter service details into the fixed wing GDS booking for security and tracking purposes and itinerary generation *Note that this process applies specifically for Client. Processes for other Oil & Gas companies will need to be clarified, however the requirement will be common for many prospect Clients

Shift Plot Movements

(Also known as Core Crew Movements, Crew Rotations, FIFO (Fly In Fly Out))

Considerations and Information

The key development objective is to provide the ability for data to be pulled from a source similar to the attached spread sheet example and for this data to be used in an automated booking process via Serko Online.
The number of days for rotations will vary by company and by type of employee. The rotations could be two weeks on, then one week off or eight days on and six days off or any other variation according to individual company requirements. For the example provided by Client, the rotation is two weeks on and one week off.
Clients will want to book three to four sequences of rotations in a single bulk load. Booking numbers could vary anywhere from fifty to three hundred or more depending on requirements.
Clients prefer want to manage the process themselves rather than relying on the TMC, therefore requiring the automated booking process to be enabled via Serko Online.
Additionally, in order to manage the entire process internally, Clients want to ability to make and manage changes to all bookings. Particularly important is the ability to make changes post ticketing so these requests do not have to be sent back to the TMC.
Bookings need to be individual passengers.

Fare Types
In general, Clients will have negotiated agreements with one or more of the major airlines.
Any potential Client with a travel expenditure exceeding 1.5M-2M dollars is eligible for an agreement.
Due to the enormous demand for seats on the common routes (Karratha, Port Hedland, Broome, Exmouth, Newman & Kalgoorlie), none of the major airlines load inventory at the lower cost end of the fares grid. As such, Best Fare of the Day (BFOD) policies are not a feasible cost option and the best private fare that can be negotiated by the Client becomes the BFOD for the Client.
For Western Australia, one of the major airlines holds the main market share of negotiated agreements with the target Client base. Most agreements will have ‘B’ class and a ‘Y’ class option, with B class at a slightly lower cost. When booking, the first option will be to secure B class and then Y class if the B class inventory has been sold. Y class will be the only last seat availability class.

Form of Payment

In general, there will be a single credit card form of payment.

Shutdown Movements

Considerations and Information

Shutdowns are scheduled regularly for major maintenance work to take place on some part, or all of, the mine site or offshore facility (e.g. rig or vessel). These can occur once or twice a year with a significant notice period or could be scheduled urgently in the case of emergency maintenance being required.
Shutdowns can require the movement of up to or sometimes exceeding 1,000 travellers within a 2-3 day period to a single destination.
Contractors feature significantly in shutdown travel requirements as all type of maintenance work (e.g. electrical, mechanical, and geological) is required to be done at the same time to minimise the down time of the mine site or facility.
When booking shutdown travel, there will need to be an identifying field in order to identify which Contractor company each traveller is working with.

Fare Types

Refer to ‘Fare Types’ for Shift Plot Movements.

Form of Payment

In general, there will be a single credit card form of payment but there could be some Client specific requirements that will need understanding and scoping.

Helicopter or Alternative Connecting Services

There is regularly a requirement for travellers to connect from a fixed wing flight to an alternative service in order to arrive onsite. This is particularly relevant to the Oil & Gas industry where travellers are booked on offshore helicopter services to take them to the rig or vessel.
At present, the TMC booking process* for a traveller is:
Make the fixed wing booking via the GDS
Make the helicopter service booking in the Client's software system for the helicopter inventory
Manually load the helicopter service details into the fixed wing GDS booking for security and tracking purposes and itinerary generation
If we were able to remove this manual process for loading the helicopter service bookings by taking a feed from the applicable Client system and having it load into the applicable GDS booking it would be a major selling tool. *Note that this process applies specifically for Client. Processes for other Oil & Gas companies will need to be clarified, however the requirement will be common for many prospect Clients.

Onsite Accommodation Management

Due to the remote locations of the sites, potential Clients will most likely have built their own accommodation camps. At present Clients are managing the camp accommodation inventory separate to the flight booking process, resulting in an inefficient manual process to ensure travellers have accommodation confirmed and the inefficient use (or non-use) of camp rooms in many circumstances.
Being able to offer an inventory management system integrated with the flight bookings would provide Serko with a significant market advantage.
In the case of Client as a particular example having recently met with The Hotel Network, there is potential interest in the product but development work to be done to meet the needs of Client.
It needs to be determined whether the development work required could meet the needs of a broader section of the potential client base and not just be Client specific.

### VARIATIONS

The booking process may book an individual's trip complete with any transfers, overnight stops, meals etc. thus completely automating the booking process.

The description relates to interfacing with a generic booking system, but can interface with the Amadeus commercial booking system.

The term “crew movement” is synonymous with many other terms for the bulk travel of individuals to a common destination whether together or individually.

### INDUSTRIAL APPLICABILITY

The invention relates to the process of providing data to a booking tool and booking travel or accommodation with the aid of manual input allowing a decreased work time for the booking process. The process therefore results in a reduction in manual costs and is industrially applicable.

What is claimed is:

1. A machine readable bulk booking computer file for one or more trips relating to the travel of a number of individuals to or from a destination, suitable for a crew movement or shift rotation where a number of individuals are scheduled to be at a specified destination at a specified time or are to be returned to their starting points at the end of their shift, the bulk booking file adapted for use with a booking computer system, the bulk booking file containing:
details of the corporate body to which it applies
the destination of each individual,
details of each individual of the number of individuals,
details of where each individual is travelling from,
time parameters for individual travel,
additional individual travel details relating to the travel for the corporate body and
additional profile details of each individual of the number of individuals and
additional travel policies or rule properties of the corporate body relating to the travel for the corporate body of each individual of the number of individuals.

2. A machine readable bulk booking computer file for one or more trips relating to the travel of a number of individuals to or from a destination, suitable for a crew movement or shift rotation where a number of individuals are scheduled to be at a specified destination at a specified time or are to be returned to their starting points at the end of their shift, as claimed in claim 1, wherein the bulk booking file is chosen from the group comprising XML documents and spreadsheets.

3. A machine readable bulk booking computer file for one or more trips relating to the travel of a number of individuals to or from a destination, suitable for a crew movement or shift rotation where a number of individuals are scheduled to be at a specified destination at a specified time or are to be returned to their starting points at the end of their shift, as claimed in claim 2 wherein the bulk file contains conditional values relating to at least some of the time parameters specified for individual travel, the conditional values specifying the allowable variance from the time specified in the bulk file.

4. A machine readable bulk booking computer file for one or more trips relating to the travel of a number of individuals to or from a destination, suitable for a crew movement or shift rotation where a number of individuals are scheduled to be at a specified destination at a specified time or are to be returned to their starting points at the end of their shift, as claimed in claim 3 wherein the bulk file also includes the identification of an applicable cost centre for the or each trip.

5. A method of bulk booking travel for a number of individuals for a corporate body by:
providing a booking computer system,
storing in the booking computer system travel policies or rules of the corporate body,
storing in the booking computer system the profile details of the number of individuals travelling,
creating externally to the computer system a bulk booking file relating to the travel for the corporate body of a number of individuals to or from a destination such as a crew movement or shift rotation,
the booking computer system reading a bulk file relating to a defined trip as claimed in claim 1,
creating within the booking computer system a trip relating to the travel of the number of individuals to a destination,
the booking computer system retrieving the stored travel policies or rules of the corporate body the corporate body travel policies or rules applicable for the trip,
the booking computer system retrieving the stored profile details of the individual,
the booking computer system retrieving the individual travel details and additional profile details of the individual and additional travel policies or rule properties of the corporate body from the bulk booking file,
the booking computer system merging the retrieved stored travel policies or rules of the corporate body applicable for the trip, the retrieved stored individual profile details, the retrieved bulk booking file additional profile details of the individual and the retrieved bulk booking file travel policies of the corporate body into a prioritized set of rules,
the booking computer system individually checking for errors the individual travel details of each individual and travel to the destination in accordance with the prioritized set of rules and either:
booking travel for the individual and issuing the bookings
or:
reporting warnings or errors in the trip bookings.

6. A method of bulk booking travel for a number of individuals for a corporate body by:
providing a booking computer system,
storing in the booking computer system travel policies or rules of the corporate body,
storing in the booking computer system the profile details of the number of individuals travelling,
creating externally to the computer system a bulk booking file relating to the travel for the corporate body of a number of individuals to a destination,
verifying the content of the bulk file at least in relation to travel services and resolving the travel services to relate to bookable travel,
uploading the external bulk file to the booking computer system,
the bulk booking file including details of each individual of the number of individuals, additional individual travel details relating to the travel for the corporate body and additional profile details of each individual of the number of individuals and additional travel policies or rule properties of the corporate body relating to the travel for the corporate body of each individual of the number of individuals,
creating within the booking computer system a trip relating to the travel of a number of individuals to a destination,
the booking computer system retrieving the stored travel policies or rules of the corporate body the corporate body travel policies or rules applicable for the trip,
the booking computer system retrieving the individual travel details and additional profile details of the individual and additional travel policies or rule properties of the corporate body from the bulk booking file,
the booking computer system retrieving the stored profile details of the individual,
the booking computer system merging the retrieved stored travel policies or rules of the corporate body applicable for the trip, the retrieved stored individual profile details, the retrieved bulk booking file additional profile details of the individual and the retrieved bulk booking file travel policies of the corporate body into a prioritized set of rules,
the booking computer system individually checking for errors the individual travel details of each individual and travel to the destination in accordance with the prioritized set of rules and either:
booking travel for the individual and issuing the bookings
or:
reporting warnings or errors in the trip bookings.

7. A method as claimed in claim 6 wherein the warnings or errors include the booking information which most nearly met the prioritized set of rules.

8. A method as claimed in claim 6 wherein the bulk booking file contains conditional values relating to at least some of the time parameters specified for individual travel, the conditional values specifying the allowable variance from the time for that parameter specified in the bulk booking file.

9. A travel booking computer system for bulk booking the travel of a number of individuals by a corporate body and having:
a storage capable of storing details of the corporate body travel policy or rules and the individual travel profiles,
a bulk booking file parser capable of reading an uploaded bulk booking file,
the bulk booking file including details of at least one required destination of a number of individuals, details of the individuals sufficient to create a booking, details of any additional individual travel policies and any additional corporate travel policies for the travel,
a merger sub-system capable of merging the corporate body, individual traveler and bulk booking file policies, details and profiles into a prioritized set of rules,
access to a travel booking provider,
a travel booker capable of:
individually checking with the travel booking provider the travel of each of the number of individuals to the destination in compliance with the prioritized set of rules from the merged corporate body, individual traveler and bulk booking file policies, details and profiles,
and where found to be in compliance with the prioritized rules from the merged corporate body, individual traveler and bulk booking file policies, details and profiles booking the checked travel and issuing the booking
and otherwise reporting a warning or an error.

10. A travel booking computer system as claimed in claim 9 wherein the warnings or errors include the booking information which most nearly met the prioritized set of rules.

11. A travel booking computer system as claimed in claim 9 wherein the bulk booking file contains conditional values relating to at least some of the time parameters specified for individual travel, the conditional values specifying the allowable variance from the time specified in the bulk booking file.
